(19) United States
(12) Patent Application Publication
(10) Pub. No.: US 2003/0210799 A1
(43) Pub. Date: Nov. 13, 2003

(54) Multiple membrane structure and method of manufacture

(76) Inventors: Kaigham J. Gabriel, Pittsburgh, PA (US); Xu Zhu, Pittsburgh, PA (US); Huikai Xie, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 10/143,280

(22) Filed: May 10, 2002

(51) Int. Cl. H04R 1/02; H04R 25/00

(52) U.S. Cl. 381/173; 381/91; 381/171; 381/190

(57) ABSTRACT

A direct digital microphone is constructed of a plurality of first membranes each formed by a micro-machined mesh supported by a substrate. Each of the membranes has a first and a second position. A second membrane is supported by the substrate and positioned above the plurality of first membranes to form a chamber between the plurality of first membranes and the second membrane. A pressure sensor is responsive to pressure in the chamber. Drive electronics are responsive to the pressure sensor for controlling the positions of each of the plurality of first membranes. Output electronics are responsive to the positions of the plurality of first membranes to produce a digital output signal. A stacked membrane structure and methods of fabrication and operation are also disclosed.

### BACKGROUND OF THE INVENTION

1. Field of the Invention

The present invention is directed to micro-electromechanical system (MEMS) devices and, more particularly, to MEMS devices which include a flexible membrane.

2. Description of the Background

Currently, acoustic devices such as microphones are geometrically symmetrical with little internal structure. They often consist of a rectangular or circular plate, or diaphragm, whose motions are detected capacitively, piezoelectrically, or piezoresistively to produce an analog signal. One difficulty in microphone design is in providing a device having a sufficiently linear response and required sensitivity over the frequencies of operation.

It is desirable to convert the analog signal produced by a microphone to a digital signal for further processing or storage. However, analog-to-digital converters raise the cost of a product because of the cost of designing and building such special and precision electronic units. For example, the current source for the most significant bit (MSB) of a multi-bit, digital representation of an analog signal must have an error of less than the least significant bit (LSB), which is usually several orders of magnitude smaller than the MSB. A 14-bit analog to digital converter requires the resolution and accuracy at 1/16384. The need exists for a microphone that overcomes linearity problems and the cost and difficulties associated with converting an analog signal to a digital signal.

### SUMMARY OF THE INVENTION

The present invention is a direct digital microphone which provides a digital output signal directly in response to a soundwave without the need to first produce an analog signal, and then convert the analog signal to a digital signal. The direct digital microphone is based on a structure, carried on a substrate, which is comprised of a plurality of first, lower membranes and a second, upper membrane. The lower membranes are each formed of a micromachined mesh and are each sealed with a sealing material. The upper membrane may be provided in a number of ways. First, the upper membrane may be comprised of a micromachined mesh which is fabricated and sealed above the lower membranes to form an integral structure. In another embodiment, the upper membrane is formed of a micro-machined mesh which is sealed to form a membrane. The membrane is then mechanically connected above the lower membranes to form a composite structure. In yet another embodiment, a cover membrane of a suitable material is mechanically connected above the lower membranes to form a composite structure.

The present invention is also directed to methods of fabricating a stacked structure comprising at least two membranes. The method of fabrication will vary depending upon whether an integral or composite structure is being fabricated. The method may be comprised of the steps of fabricating a first micro-machined mesh on a substrate, sealing the mesh to form a membrane, and positioning a second membrane above the first membrane. The positioning may include mechanically attaching one of a fabricated membrane and a cover membrane above the first membrane.

Another method of fabricating a stacked structure comprising at least two membranes comprises the steps of stacking alternating layers of at least two different materials on a substrate, with certain of the layers being patterned. A top layer is used as an etch mask to form an upper mesh. After the upper mesh is formed, the top layer is removed to expose a new top layer. The new top layer is used to protect the upper mesh while the upper mesh is released from the substrate. The new top layer is then removed. The upper mesh is used as an etch mask to form and release a lower mesh from the substrate. A sealant is then deposited for sealing the lower meshes and the upper mesh.

The present invention is also directed to a method of fabricating stacked layers comprising forming a first layer of a first material, e.g. oxide, and a first layer of a second material, e.g. metal. The first layer of the second material is patterned to form a lower mesh. A second layer of the first material and a second layer of the second material are then formed. The second layer of the second material is patterned to define a chamber above the lower mesh. A third layer of the first material and a third layer of the second material are formed. The third layer of the second material is patterned to form an upper mesh above the chamber. A fourth layer of the first material and a fourth material of the second material are formed. The fourth layer of the second material is patterned to act as an etch mask for forming the upper mesh. The foregoing method will likely be performed by a CMOS foundry to provide a structure having a number of stacked layers. The structure may then be processed according to a post-processing fabrication process to produce a structure having stacked membranes. The post-processing fabrication process may include the steps of: forming an upper micro-machined mesh on a substrate; releasing the upper mesh; forming and releasing a lower mesh under said upper mesh; and sealing the upper and lower meshes to form first and second membranes, respectively.

As mentioned, the structure of the present invention may be used to construct, for example, a microphone. A microphone constructed of such a device is comprised of a plurality of first membranes each formed by a micro-machined mesh supported by a substrate. Each of the membranes has a first (up) and a second (down) position. A second membrane is supported by the substrate and positioned above the first membranes to form a chamber between the plurality of first membranes and the second membrane. A pressure sensor is responsive to pressure in the chamber. Drive electronics are responsive to the pressure sensor for controlling the positions of each of the plurality of first membranes. Output electronics are responsive to the positions of the plurality of first membranes to produce a digital output signal.

A method of converting soundwaves directly to a digital signal is also disclosed. The method is comprised of sensing a pressure in a chamber formed of an upper membrane and a plurality of lower membranes. Each of the lower membranes has first and second positions and each of the lower membranes is constructed of a micro-machined mesh. The method also comprises controlling, in response to the sensing, whether each of the plurality of lower membranes is in its first or its second position. A digital signal responsive to the positions of each of the plurality of lower membranes is output.

The present invention provides a substantial advance over the prior art in that it provides for the direct conversion of a soundwave into a digital signal thereby eliminating the steps of producing an analog signal and converting the analog signal to a digital signal. The microphone may be built around a stacked membrane structure having a chamber between the membranes. By measuring the pressure in the chamber, and using the positions of the plurality of lower membranes to maintain the pressure in the chamber constant, problems associated with maintaining linearity of the pressure measurement over a large range are eliminated. The microphone can be constructed to be extremely sensitive around the ambient (or starting) pressure because the control of the positions of the lower membranes keeps the pressure very close to the ambient (or starting) pressure. Furthermore, because the microphone may be built using CMOS design techniques, advances in CMOS design can be directly incorporated into the construction of the direct digital microphone of the present invention. Extremely small and precise microphones can be fabricated which can be employed in a variety of electronic devices such as hearing aids, cell phones, and others. Those advantages and benefits, and others, will be apparent from the Description of the Preferred Embodiments herein below.

### BRIEF DESCRIPTION OF THE DRAWINGS

For the present invention to be easily understood and readily practiced, the present invention will now be described, for purposes of illustration and not limitation, in conjunction with the following figures, wherein:

FIG. 1 is a block diagram of a digital microphone constructed according to the teachings of the present invention;

FIG. 2 is a diagram representing a top view looking down onto a digital microphone of the type represented by the block diagram of FIG. 1;

FIG. 3 is a cross-sectional view taken along the lines III-III in FIG. 2;

FIG. 4 illustrates a substrate after a first layer of a first material, e.g. oxide, and a first layer of a second material, e.g. metal, have been formed;

FIG. 5 illustrates the substrate of FIG. 4 after the first layer of the second material, e.g. metal, has been patterned to form two lower meshes;

FIG. 6 illustrates the substrate of FIG. 5 after a second layer of the first material, e.g. oxide, and a second layer of the second material, e.g. metal, have been formed, and the second layer of the second material has been patterned to define a chamber above the two lower meshes;

FIG. 7 illustrates the substrate of FIG. 6 after a third layer of the first material, e.g. oxide, and a third layer of the second material, e.g. metal, have been formed, and the third layer of the second layer has been patterned to form an upper mesh;

FIG. 8 illustrates the substrate of FIG. 7 after a fourth layer of the first material, e.g. oxide, and a fourth layer of the second material, e.g. metal, have been formed, and the fourth layer of second material has been patterned to function as an etch mask for the upper mesh;

FIG. 9 illustrates the substrate of FIG. 8 after another layer of the first material, e.g. oxide, has been formed;

FIG. 10 illustrates the substrate of FIG. 9 after the first post-processing step has been performed and the top layer of the second material, e.g. metal, is used as an etch mask for the first material, e.g. oxide;

FIG. 11 illustrates the substrate of FIG. 10 after an etch of the second material, e.g. metal, has been performed and a chamber formed under the upper mesh to release the upper mesh;

FIGS. 12A and 12B illustrate the substrate of FIG. 11 after an etch of the first material, e.g. oxide, which forms and releases the lower meshes;

FIGS. 13A and 13B illustrate the sealing of the upper and lower meshes; and

FIG. 14 is a schematic of a four-bit, direct, digital microphone constructed according to the present invention.

### DESCRIPTION OF THE PREFERRED EMBODIMENTS

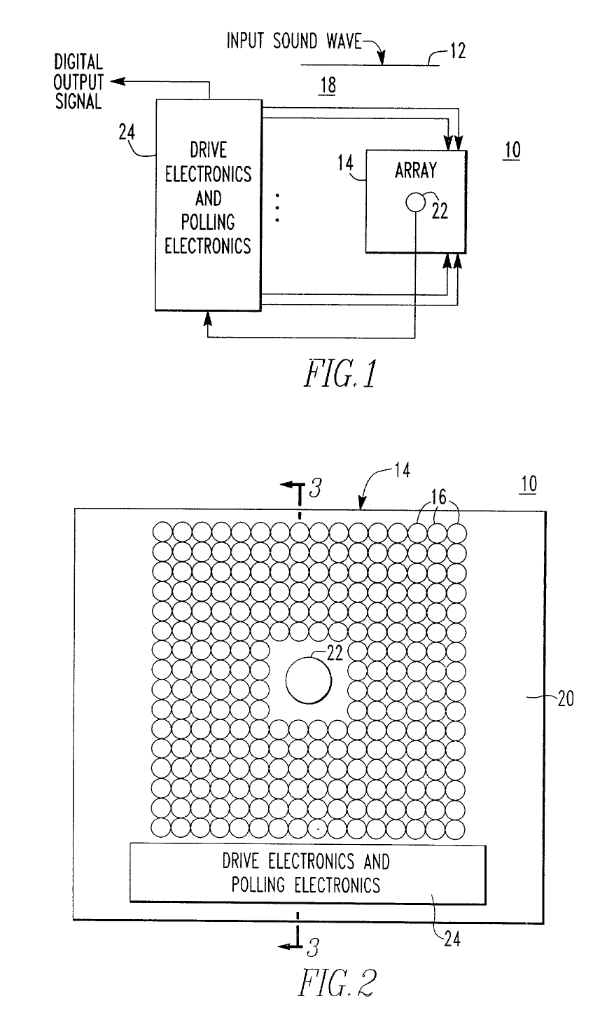

A direct digital microphone 10 constructed according to the teachings of the present invention will now be described in conjunction with FIGS. 1, 2 and 3. FIG. 1 is a block diagram of the direct digital microphone 10. FIG. 2 is a representation of a top view looking down onto a direct digital microphone 10 of the type represented by the block diagram of FIG. 1 while FIG. 3 is a cross-sectional view taken along the lines III-III in FIG. 2. The microphone 10 is comprised of an upper membrane 12, seen in FIGS. 1 and 3. The upper membrane 12 is not shown in FIG. 2. Positioned beneath the upper membrane 12 is a plurality or array 14 of individual lower membranes 16. The lower membranes 16 are sometimes referred to herein as first membranes while the upper membrane 12 is sometimes referred to herein as the second membrane. A chamber 18, seen best in FIG. 3, is formed between the lower membranes 16 and upper membrane 12. The array 14 of lower membranes 16 and the upper membrane 12 are all supported by a substrate 20. The substrate 20 also carries a pressure sensor 22 and electronics 24. The electronics 24 may include drive electronics and polling (or output) electronics as will be described.

As a soundwave impinges on the upper membrane 12, the upper membrane 12 deflects proportionally to the sound pressure causing a change in volume of chamber 18. The change in volume happens quickly compared to the time needed for heat flow, such that an adiabatic compression or expansion takes place, changing the pressure of the air within the chamber 18. The pressure sensor 22 senses if the pressure of the air in the chamber 18 deviates from atmospheric (or starting) pressure. Drive electronics 24 are responsive to the pressure sensor 22.

Each of the lower membranes 16 has first and second positions. A first position, for example an equilibrium position, may be representative of a logic “0” while a second position, which may be achieved through the application of, for example, a charge differential between the membrane and the substrate, may be representative of a logic “1”. The drive electronics, responsive to the sensor 22, will control the position of the individual membranes 16 to maintain a constant pressure in chamber 18. Thus, the sensor 22, drive electronics 24, and array 14 of individual membranes 16 may be thought of as a negative feedback loop. Because each of the individual membranes 16 is in either one of its two states, the pressure/volume correction the individual membranes implement is proportional to the number that are deflected (i.e. in their second state). Polling electronics keep track of the number of membranes that are deflected at any time, for example, by determining how many are activated by their associated drive electronics. The number of individual membranes 16 that are deflected may be directly output as a digital signal representative of the pressure sensed by the upper membrane 12.

The pressure sensor 22 may be a capacitive or piezoresistive sensor comprised of a membrane similar to membranes 16, but larger. Because the pressure sensor 22 only has to measure whether the pressure is above or below the equilibrium or starting pressure, there is no requirement for linearity. Instead, high sensitivity around the equilibrium pressure is a main design concern. A polysilicon heater (not shown), or other type of heater, may be integrated inside or near the pressure sensor 22 to set the mechanical operating point and maximize sensitivity.

The array 14 of individual membranes 16 may be a uniformly distributed n x n array. Each membrane 16 snaps independently and in a predetermined sequence between its first at “rest” (up) position and its second “deflected” (down) position. The sensed sound pressure is measured in n² levels and thus digitized electromechanically. In another embodiment, the array 14 may be divided into groups. Each group has a certain number of membranes 16 assigned to it that snap simultaneously as a group. The number of membranes 16 in each group represents the weight significance of that group. For example, a group with one membrane corresponds to the least significant bit, a group with two membranes corresponds to the next least significant bit, and so forth. If an 8-bit direct digital microphone is needed, the membranes may be divided into eight groups with each group having 1, 2, 4, 8, 16, 32, 64 and 128 individual membranes, respectively. In yet another embodiment, the size of the individual membranes 16 may be varied such that the next least significant bit is twice the area of the least significant bit, the next bit has four times the area of the least significant bit, the next bit has eight times the area of the least significant bit, etc. The array 14 may be comprised of hundreds or thousands of individual membranes 16.

The electronics 24 may include, but are not limited to, preamplifiers, operational amplifiers, charge pumps, select circuits, etc. The electronics 24 may include an interface between the sensor 22 and the drive electronics which control the positions of the individual membranes 16. The construction and operation of the electronics 24 is considered conventional and not further described herein.

The direct digital microphone 10 of the present invention is constructed around a stacked structure, i.e. an upper membrane 12 positioned above one or more lower membranes 16. At least the lower membranes 16 are comprised of a micro-machined mesh which is sealed. Construction of such a sealed mesh is known. See, for example, International Publication No. WO 01/20948 A2, published Mar. 22, 2001 which is hereby incorporated by reference. We turn next to a discussion of how to fabricate such a stacked structure.

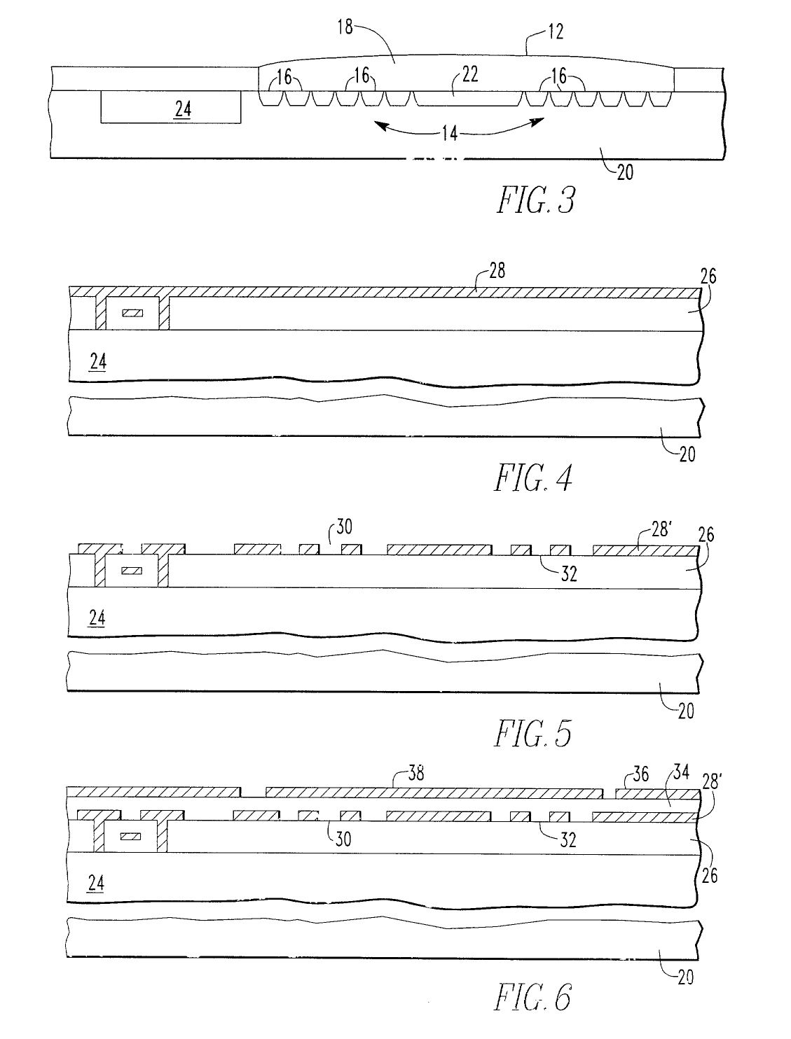

In FIG. 4, the substrate 20 is shown after having been subjected to a CMOS fabrication process to produce electronics 24. The fabrication of the electronics 24 does not form a feature of the present invention and therefore is not discussed. Upon substrate 20, a first layer 26 of a first material, e.g oxide, is formed. The first layer 26 of the first material, e.g. oxide, may be formed in any conventional manner such as, for example, deposition or, in the case of oxide, thermally oxidizing substrate 20. Thereafter a first layer 28 of a second material, e.g. metal (in this case aluminum), is formed using any appropriate technique. The layer 28 of the second material is then patterned using any known techniques such as applying photoresist, curing the photoresist according to a mask, and then removing portions of the layer 28 of the second material resulting in the patterned layer 28′ shown in FIG. 5. The layer 28 may be patterned in the area of electronics 24 so as to interconnect components to provide the desired functions. More importantly, the patterned layer 28′ provides a mesh 30 and a mesh 32 of the type disclosed, for example, in WO 01/20948 and which will be released and formed into membranes according to the process described below.

Turning now to FIG. 6, a second layer 34 of the first material and a second layer 36 of the second material are formed on substrate 20. The second layer 36 of the second material 36 is patterned to have a portion 38 defining a chamber, the function of which will be described herein below.

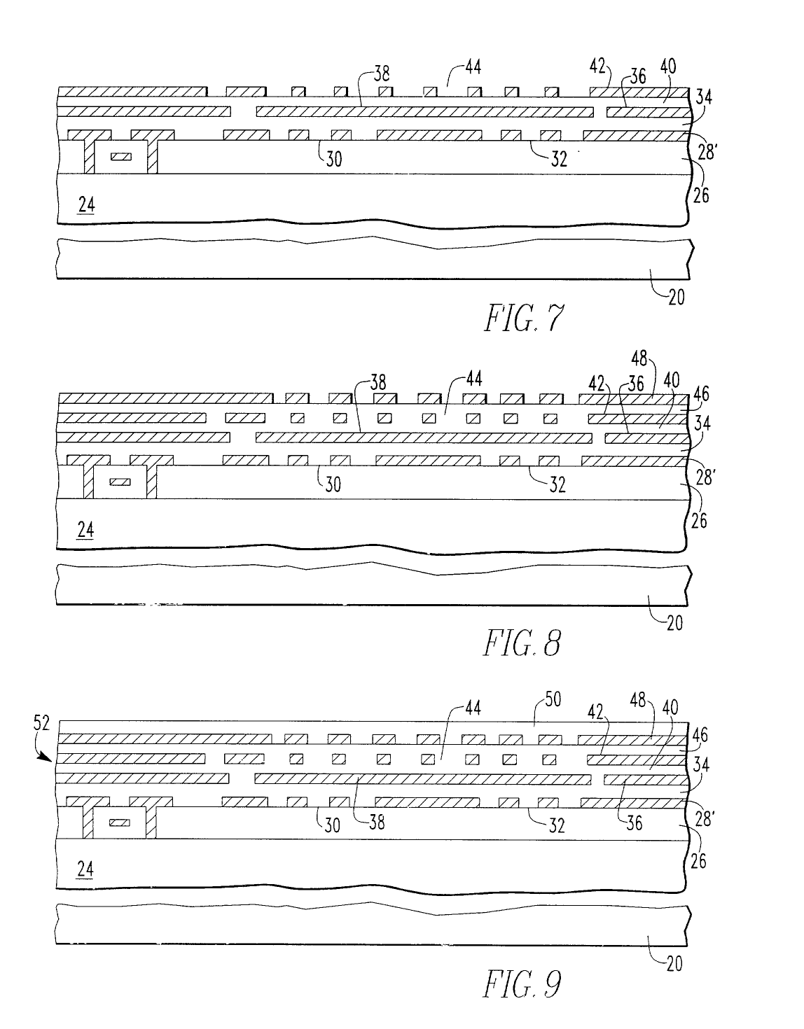

In FIG. 7, a third layer 40 of a first material and a third layer 42 of the second material are formed. The third layer 42 of the second material is patterned to form a mesh 44 of the type disclosed in, for example, WO 01/20948. In FIG. 8, a fourth layer 46 of the first material and a fourth layer 48 of the second material are formed. The fourth layer 48 of the second material is patterned so as to provide an etch mask for forming the upper mesh 44 as will be described below. To enable the layer 48 of the second material to function as an etch mask, the width of the beams forming the mesh 44 may be approximately 0.2 μm less than the width of the beams forming the pattern formed in the layer 48 of the second material. Thereafter, as shown in FIG. 9, another layer 50 of the first material may be formed.

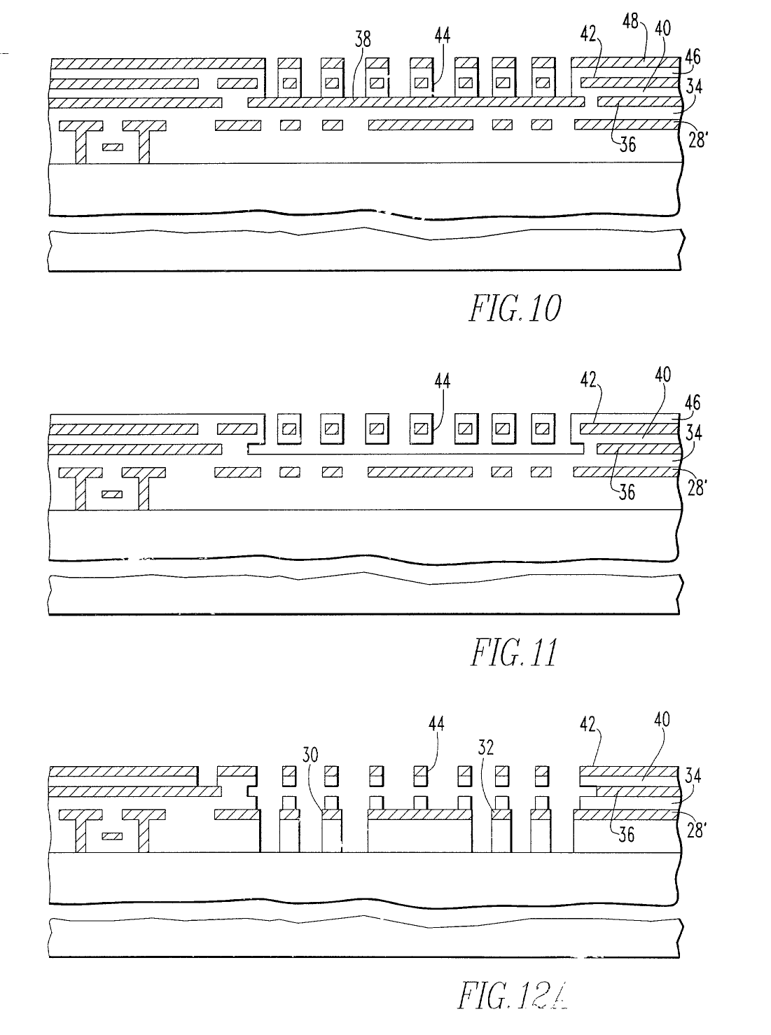

It is anticipated that the stacked structure 52 shown in FIG. 9 will be produced by a CMOS foundry. Thereafter, the stacked structure 52 will be subjected to post-processing steps, described in conjunction with FIGS. 10-13B, to fabricate an integral stacked membrane structure. Although the stacked structure 52 has been described in conjunction with CMOS processing and alternate layers of a first material, e.g. oxide, and a second material, e.g. metal, other processing techniques and other materials may be used while remaining within the scope of the present invention. One criterion for selecting materials is to select materials which are responsive to different etching processes, so that one material may be used as a mask, while the other material is being etched, as will become more apparent from the description of the post-processing steps illustrated in FIGS. 10-13B.

In FIG. 10, the top layer 50 of the first material, e.g. oxide, has been removed using an etch selective to the first material, e.g. an oxide etch. The first material etch also etches through the layers 46, 40 of the first material using the new top layer, the fourth layer 48 of the second material as an etch mask. Any directional first material etching technique may be used. When the first material etch etches through the fourth layer 46 of the first material, the upper mesh 44 is formed, but is encased in the first material. Etching stops upon reaching the layer 36 of the second material.

In FIG. 11, it is seen that the new top layer, i.e. the fourth layer 48 of the second material has been removed to expose yet another new top layer, fourth layer 46 of the first material. The fourth layer 46 of the first material is used to protect the mesh 44 while allowing the portion 38 to be removed through an isotropic etch of the second material. With portion 38 removed as seen in FIG. 11, the upper mesh 44 is released from the substrate. Because the mesh 44 is imbedded in the first material, e.g. oxide, on both its faces forming a symmetric stress distribution, buckling is expected to be minimal.

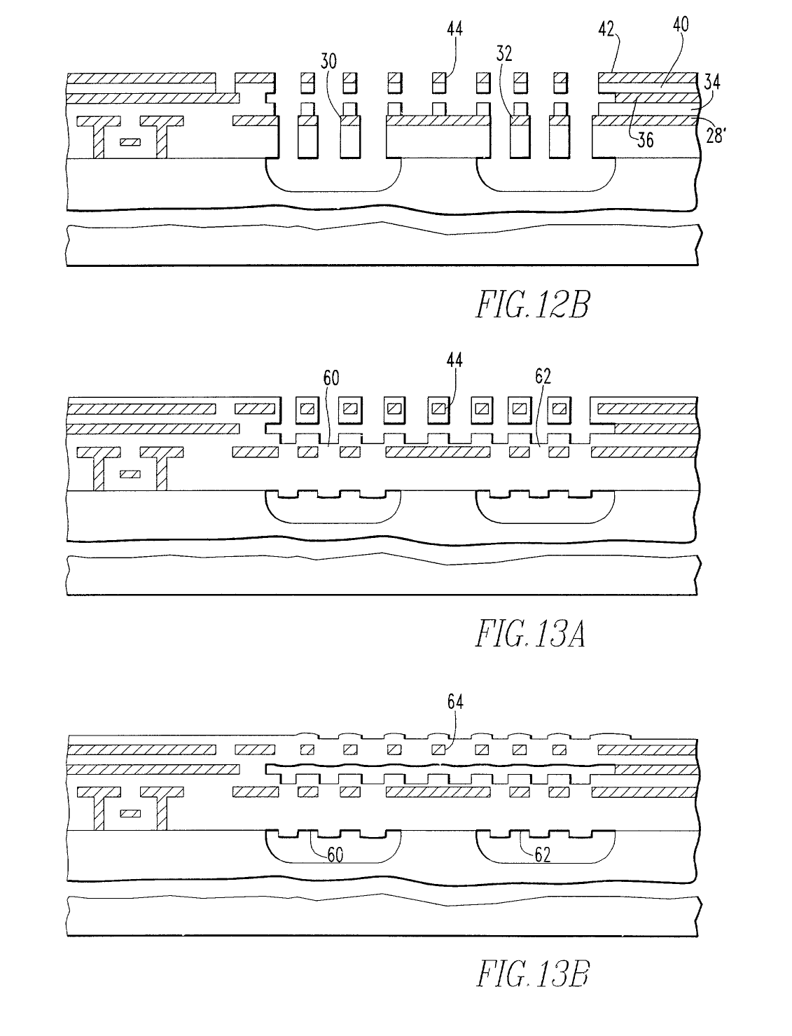

The new top layer 46 of the first material is stripped as shown in FIG. 12A using an etch selective to the first material, e.g. oxide, which also etches through the layers 34, 26 of the first material. As shown in FIG. 12A, when the layer 26 of the first material is etched, the individual meshes 30, 32 are formed. Continuation of the etching step, or as a result of a separate step, the silicon substrate is undercut as illustrated in FIG. 12B thereby releasing meshes 30, 32. The separation between lower meshes 30, 32 and upper mesh 44 may be approximately 1 to 3 μm.

After the lower meshes 30, 32 have been released, a polymer deposition step is performed which first seals the lower meshes as seen in FIG. 13A to form membranes 60, 62, which are two examples of the membranes 16 of FIG. 2, and then to form membrane 64, which performs the function of the upper membrane 12 illustrated in FIGS. 1 and 3. To insure that the lower meshes 30, 32 are sealed before the upper mesh 44, the upper mesh may be constructed to have gaps between the beams which are larger than the gaps between the beams forming lower meshes 30, 32. For example, the gaps between the beams forming the upper mesh 44 may be approximately 1.5 μm while the gaps between the beams forming the lower meshes 30, 32 may be approximately 0.5 μm. Accordingly, the beams forming lower meshes 30, 32 may be wider than the beams forming upper mesh 44.

A similar technique may be used with a three-metal CMOS process to create meshes in metal 2, very close to the substrate, even though metal 3 would be sacrificed in such a process.

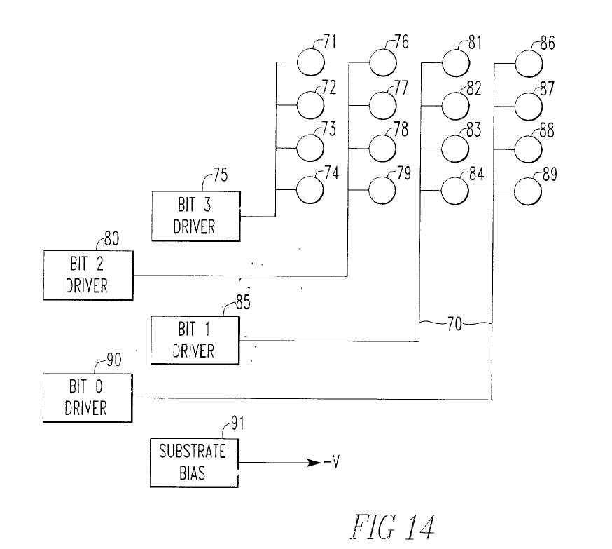

Those of ordinary skill in the art will recognize that the pattern used to form the lower meshes may also be used to form traces 70, shown in FIG. 14, for interconnecting the lower meshes to drivers. As shown in FIG. 14, lower meshes 71-74 are connected to bit 3 driver 75, three of lower meshes 76-79 are connected to bit 2 driver 80, two of lower meshes 81-84 are connected to bit 1 driver 85, and one of lower meshes 86-89 are connected to bit 0 driver 90. A substrate bias 91 may be used to bias the substrate at, for example, a negative voltage. Through the application of a positive voltage via bit drivers 75, 80, 85, 90 to the lower meshes, the position of the membranes can be controlled.

In another embodiment of the present invention, the CMOS process is used to build up stacks of alternating materials sufficient to form micro-machined meshes which may then be sealed by a sealing material. In one area of the substrate, the plurality of lower meshes is formed, and in another area of the substrate the upper mesh is formed. After sealing of all of the meshes, the substrate is cut, and the upper membrane is mechanically bonded in a face-to-face fashion so that it is positioned over the plurality of lower membranes to form a composite device. Such a bonding technique could be used in both a chip-to-chip fashion or at the wafer level.

In yet another embodiment in which a composite device is produced, a cover membrane is a passive component which is simply glued or otherwise mechanically attached above the array of lower membranes. The cover membrane may be a thin layer of plastic or polymer mechanically attached to a chip having formed thereon the array 14 of lower membranes 16, the pressure sensor 22 and electronics 24. Of course, the integrated approach discussed above eliminates problems accompanying mechanically attaching the upper membrane such as sealing and alignment.

While the present invention has been described in conjunction with preferred embodiments thereof, those of ordinary skill in the art will recognize that many modifications and variations may be implemented while still falling within the scope of the present invention. For example, processing techniques other than CMOS techniques may be utilized. Other types of materials and process steps may be substituted for those described in the preferred embodiment while remaining within the scope of the present invention. The description of presently preferred embodiments is not intended to limit the scope of the present invention, which is defined by the following claims.

What is claimed is:

1. A structure carried on a substrate, comprising:
a first membrane formed of a micro-machined mesh supported by the substrate; and
a second membrane supported by the substrate and positioned above said first membrane to form a chamber therebetween

2. The structure of claim 1 wherein said first and second membranes are fabricated one above the other to form an integral structure.

3. The structure of claim 1 wherein said second membrane is mechanically connected above said first membrane to form a composite structure.

4. The structure of claim 3 wherein said second membrane is one of a fabricated membrane and a cover membrane.

5. The structure of claim 1 wherein said first membrane is comprised of a first micro-machined mesh and a first material sealing said mesh and wherein said second membrane is comprised of a second micro-machined mesh and a second material sealing said second mesh.

6. The structure of claim 5 wherein said first material and said second material are the same.

7. A structure carried on a substrate, comprising:
a first micro-machined mesh supported by the substrate;
a second micro-machined mesh supported by the substrate and positioned above said first mesh; and
a material for sealing said first and second meshes to form first and second membranes, respectively.

8. The structure of claim 7 wherein said first and second membranes are fabricated one above the other to form an integral structure.

9. The structure of claim 8 wherein the gaps of said second mesh are larger than the gaps of said first mesh.

10. The structure of claim 7 wherein said second membrane is mechanically connected above said first membrane to form a composite structure.

11. A stacked structure comprising at least two membranes, and wherein at least one of said membranes is formed of a micro-machined mesh.

12. The structure of claim 11 wherein said at least two membranes are fabricated one above the other to form an integral structure.

13. The structure of claim 11 wherein a top one of said at least two membranes is mechanically connected to said stack.

14. The structure of claim 13 wherein said top one of said at least two membranes is one of a fabricated membrane and a cover membrane.

15. The structure of claim 11 wherein said at least two membranes are comprised of a first micro-machined mesh and a first material sealing said mesh and a second micro-machined mesh and a second material sealing said second mesh.

16. The structure of claim 15 wherein said first material and said second material are the same.

17. A microphone constructed on a substrate, comprising:
a plurality of first membranes each formed by a micro-machined mesh supported by the substrate, each of said membranes having a first and a second position;
a second membrane supported by the substrate and positioned above said first membrane to form a chamber between said plurality of first membranes and said second membrane;
a pressure sensor responsive to a pressure in said chamber;
drive electronics responsive to said pressure sensor for controlling the positions of each of said plurality of first membranes; and
output electronics responsive to the positions of said plurality of first membranes.

18. The microphone of claim 17 wherein each of said plurality of first membranes is substantially identical in size.

19. The microphone of claim 17 wherein each of said plurality of first membranes is a multiple of a base sized membrane.

20. The microphone of claim 17 wherein said pressure sensor is one of a capacitive sensor and a piezoresistive sensor.

21. The microphone of claim 17 additionally comprising a heater carried by the substrate.

22. The microphone of claim 17 wherein said plurality of first membranes and said second membrane are fabricated one above the other to form an integral structure.

23. The microphone of claim 17 wherein said second membrane is mechanically connected above said plurality of first membranes to form a composite structure.

24. The microphone of claim 23 wherein said second membrane is one of a fabricated membrane and a cover membrane.

25. The microphone of claim 17 wherein each membrane of said plurality of first membranes is comprised of a first micro-machined mesh and a first material sealing said mesh and wherein said second membrane is comprised of a second micro-machined mesh and a second material sealing said second mesh.

26. The microphone of claim 25 wherein said first material and said second material are the same.

27. A microphone, comprising:
a substrate;
a plurality of first micro-machined meshes supported by said substrate;
a second micro-machined mesh supported by the substrate and positioned above said plurality of first meshes to form a chamber therebetween;
a material for sealing said plurality of first meshes to form a plurality of first membranes and for sealing said second mesh to form a second membrane, each of said plurality of first membranes having first and second positions;
a sensor responsive to said chamber;
drive electronics responsive to said sensor for controlling the positions of each of said plurality of first membranes; and
output electronics responsive to the positions of said plurality of first membranes for producing an output signal.

28. The microphone of claim 27 wherein each of said plurality of first membranes is substantially identical in size.

29. The microphone of claim 27 wherein each of said plurality of first membranes is a multiple of a base sized membrane.

30. The microphone of claim 27 wherein said sensor is one of a capacitive pressure sensor and a piezoresistive pressure sensor.

31. The microphone of claim 27 additionally comprising a heater carried by said substrate.

32. The microphone of claim 27 wherein said plurality of first membranes and said second membrane are fabricated one above the other to form an integral structure.

33. The microphone of claim 27 wherein the gaps of said second mesh are larger than the gaps of said plurality of first meshes.

34. The microphone of claim 27 wherein said second membrane is mechanically connected above said first membrane to form a composite structure.

35. A method, comprising:
fabricating a first micro-machined mesh on a substrate;
sealing said mesh to form a membrane; and
positioning a second membrane above said first membrane.

36. The method of claim 35 wherein said positioning includes mechanically attaching one of a fabricated membrane and cover membrane above said first membrane.

37. A method of fabricating stacked membranes, comprising:
stacking alternating layers of at least two different materials on a substrate, certain of said layers being patterned;
using a top layer as an etch mask to form an upper mesh;
removing said top layer to expose a new top layer;
using said new top layer to protect said upper mesh while said upper mesh is released from said substrate;
removing said new top layer;
using said upper mesh as an etch mask to form and release a lower mesh from said substrate; and
depositing a sealant for sealing said upper and lower meshes.

38. The method of claim 37 wherein said stacking includes forming alternating layers of metal and oxide, and wherein said top layer is a layer of metal.

39. The method of claim 38 wherein a first of said layers of metal is patterned to form said lower mesh, a second of said layers of metal is patterned to define a chamber, and a third of said layers of metal is patterned to form said upper mesh.

40. The method of claim 39 wherein said upper mesh has gaps of a larger size than the gaps of said lower mesh, and wherein said depositing step includes first sealing said lower mesh and then sealing said upper mesh.

41. A method of fabricating stacked layers, comprising:
forming a first layer of a first material;
forming a first layer of a second material;
patterning said first layer of said second material to form a lower mesh;
forming a second layer of said first material;
forming a second layer of said second material;
patterning said second layer of said second material to define a chamber above said lower mesh;
forming a third layer of said first material;
forming a third layer of said second material;
patterning said third layer of said second material to form an upper mesh above said chamber;
forming a fourth layer of said first material;
forming a fourth layer of said second material; and
patterning said fourth layer of said second material to act as an etch mask for forming said upper mesh.

42. The method of claim 41 wherein said first material is an oxide and said second material is a metal.

43. A method, comprising:
forming an upper micro-machined mesh on a substrate;
releasing said upper mesh;
forming and releasing a lower mesh under said upper mesh; and
sealing said lower and upper meshes to form first and second membranes, respectively.

44. The method of claim 43 wherein said sealing includes deposition of a polymer.

45. A method, comprising:
sensing a pressure between an upper membrane and a plurality of lower membranes, each of said plurality of lower membranes having a micro-machined mesh;
controlling the position of each of said plurality of lower membranes in response to said sensing; and
monitoring the positions of said plurality of membranes to provide an output signal.

46. The method of claim 45 wherein each of said plurality of lower membranes has first and second positions, and wherein said monitoring determines the position of each of said plurality of lower membranes.

47. The method of claim 45 wherein said sensing includes sensing pressure changes and wherein said controlling compensates for sensed pressure changes.

48. A method of converting sound waves to a digital signal, comprising:
sensing a pressure in a chamber formed of an upper membrane and a plurality of lower membranes, each of said lower membranes having first and second positions, each of said lower membranes having a micro-machined mesh;
controlling, in response to said sensing, whether each of said plurality of lower membranes is in its first or second position; and
outputting a digital signal responsive to the positions of each of said plurality of lower membranes.

49. The method of claim 48 wherein said plurality of lower membranes are arranged in groups, each group being responsive to produce one bit of the output digital signal.

50. The method of claim 48 wherein said plurality of lower membranes are of various sizes, each size being responsive to produce one bit of the output digital signal.
